(19) United States
(12) Patent Application Publication
(10) Pub. No.: US 2004/0246627 A1
(43) Pub. Date: Dec. 9, 2004

(54) Disc drive pivot bearing assembly

(76) Inventors: Thomas M. Durrum, Broomfield, CO (US); David P. McReynolds, Loveland, CO (US); Wallis A. Dague, Louisville, CO (US); Loutfi E. Charara, (US); David R. Lapp, Boulder, CO (US)

Correspondence Address: Seagate Technology LLC, 1280 Disc Drive, Shakopee, MN, 55379, US

(21) Appl. No.: 10/807,892

(22) Filed: Mar. 24, 2004

Related U.S. Application Data
(60) Provisional application No. 60/476,376, filed on Jun. 6, 2003.

(51) Int. Cl. G11B 5/48; G11B 21/16; G11B 5/55; G11B 21/08

(52) U.S. Cl. 360/265.6; 360/265.2

(57) ABSTRACT

An actuator assembly has a generally flat sheet metal body with upper and lower surfaces and an actuator bore passing therebetween. The actuator bore is sized to receive the bearing cartridge assembly therethrough. A plurality of tabs project inward from an interior surface of the actuator bore, wherein the tabs extend only partially along a depth of the actuator bore between the upper and lower surfaces. The tabs contact the bearing cartridge assembly and secure it within the actuator bore.

### RELATED APPLICATIONS

This application claims priority of U.S. provisional application Ser. No. 60/476,376, filed Jun. 6, 2003.

### FIELD OF THE INVENTION

This application relates generally to rotary actuators and more particularly to a method and apparatus for precisely fixing a pivot bearing to an actuator arm assembly for use in a data storage device.

### BACKGROUND OF THE INVENTION

Disc drives store digital data in magnetic or optical form on a rotating data storage disc. Modem magnetic disc drives comprise one or more rigid data storage discs that are coated with a magnetizable medium and mounted on a spindle motor for rotation at a constant high speed. In disc drives of the current generation, the spindle motor rotates the discs at speeds of up to 25,000 RPM. Information is stored on the discs in a plurality of concentric circular tracks and is accessed typically by an array of transducers (“read/write heads”) mounted to a rotary actuator assembly for movement of the heads in an arc over the surfaces of the discs. The read/write heads are used to transfer data between a desired track and an external environment.

The actuator assembly includes an actuator body, one or more actuator arms that each project radially outward from the actuator body, and one or more flexures or suspensions attached to the distal ends of each of the actuator arms. The transducers or heads are mounted on sliders carried by the flexures. The actuator body typically pivots about a stationary pivot shaft mounted to the disc drive base plate at a position closely adjacent the outer diameter of the discs. The pivot shaft is parallel with the axis of rotation of the spindle motor and the discs, so that the heads rotate in a plane parallel with the surfaces of the discs. The actuator body supports a flat coil on an opposite side of the pivot shaft from the actuator arms, suspensions, and heads, where the suspended in a magnetic field of an array of permanent magnets that are fixedly mounted to the disc drive housing. These magnets are typically bipolar pairs mounted to pole pieces that are held in positions vertically spaced from one another by spacers to form a gap. The coil, attached to the actuator body, is free to move back and forth in this gap. When controlled DC current is applied to the coil, a magnetic field is formed surrounding the coil that interacts with the magnetic field produced by the permanent magnets in the gap to cause the coil to rotate the actuator body about the pivot shaft, with the attached head suspensions and head assemblies, in accordance with the well-known Lorentz relationship. As the actuator body rotates about the pivot shaft, the heads are moved generally radially across the data tracks of the discs along an arcuate path.

Recently, advances in storage technology have greatly increased the data storage capacity of magnetic storage discs. As a result, a single storage disc is now capable of storing large amounts of data, which would have required a stack of several discs in the past. Some drive manufacturers have begun to produce disc drives having fewer discs, and even a single disc, as often a single disc may have storage capacity sufficient for a given application. One advantage to providing a drive with only one disc is that the actuator assembly must carry only one, or at most two, heads. Such an actuator assembly would have only one arm and therefore have a rotational inertia much smaller than that of conventional actuators with multiple arms. Moreover, an actuator with only one arm may be produced from a single planar sheet of material, supporting a coil at one end and a head suspension at another. This type of actuator may be more easily manufactured than conventional actuators, and is further advantageous in that it has relatively low inertia, allowing faster seek acceleration/deceleration, and having a relatively high natural resonant frequency.

In disc drives with more than one disc, the actuator assembly is typically mounted to the pivot shaft by precision ball bearing assemblies within a bearing housing that typically takes the form of a bearing cartridge having upper and lower bearings with a stationary shaft attached to an inner race and a sleeve attached to an outer race. The sleeve is secured within a bore in the actuator body using a set screw, a C-clip, a tolerance ring, or through press-fitting, while the stationary shaft typically is attached to both the housing base plate and the top cover of the disc drive. The function of this actuator assembly pivot mechanism is crucial in order for the disc drive to meet the performance requirements associated with the actuator assembly. However, a planar actuator for use in disc drives with one disc does not have the elongate bore that a conventional actuator uses to mount a conventional bearing cartridge. Thus, while the conventional actuator bearing assembly has been found to be generally satisfactory when combined with an actuator assembly used to access a large number of discs, it does not work well with a planar actuator assembly used in a disc drive with a single disc.

Conventional actuator assembly pivot mechanisms have a number of disadvantages for disc drives that have only a single disc, including without limitation, the following. The actuator bore wall in the actuator assembly must be of sufficient height and thickness to securely mount to the cartridge, which increases the rotational inertia of the actuator assembly and unnecessarily increases cost of manufacture and operation of the disc drive. Further, installation of the cartridge into the bore is complicated, generally requiring additional fasteners, use of adhesives, and/or requiring precision press-fitting operations. Most actuator bearings are attached by one of several complicated and time-consuming methods, including use of adhesive, clips, or tolerance rings. Although the use of tolerance rings solves a variety of problems with installation, manufacturing, and cost, tolerance rings cause performance problems, such as creating too much force on the sleeve resulting in undo pressure on the bearings causing brinelling and high runout. Clips, such as E-rings, cause problems in the seating resulting in undo twist or yaw changes in the HSA. Using adhesive, on the other hand, takes up to several minutes to cure, that create constraints time on the line and can be very labor intensive due to the clean-up that may be required. Finally, press fitting methods have a multitude of issues, including differences in the thermal expansion rates from dissimilar materials, compression rate due to tolerances, seating issues caused by the amount of force, and over press caused by tolerance and press forces.

Accordingly there is a need for an actuator and pivot assembly which is particularly suited for use with disc drives having only one disc, which is easily assembled and which has precise force distribution of the actuator body onto the bearing assembly so as to maintain responsiveness, eliminate low frequency resonances, and do this without the use of adhesives. The present invention provides a solution to this and other problems, and offers other advantages over the prior art.

### SUMMARY OF THE INVENTION

Against this backdrop the present invention has been developed.

An embodiment of the present invention is an actuator arm for use in a rotary actuator assembly that has a generally flat sheet metal body with upper and lower surfaces and an actuator bore passing therebetween. The actuator bore is sized to receive the bearing cartridge assembly therethrough. A plurality of tabs project inward from an interior surface of the actuator bore, wherein the tabs extend only partially along a depth of the actuator bore between the upper and lower surfaces. The tabs contact the bearing cartridge assembly and secure it within the actuator bore. An expansion space is formed below each of the tabs between the interior surface of the actuator bore and the bearing cartridge assembly when the bearing cartridge assembly is inserted in the bore. This allows the tabs of the actuator body to exert the correct amount of pressure on the bearing cartridge assembly to optimize disc drive performance.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is an exploded side perspective view of an actuator assembly in accordance with a preferred embodiment of the present invention in FIG. 1.

FIG. 3 is a partial sectional view of the assembly shown in FIG. 2.

FIG. 4 is an enlarged view a portion of the assembly shown in FIG. 3.

FIG. 5 is a partial top view of the actuator body shown in FIG. 1.

FIG. 6 is a sectional view along lines 6-6 of FIG. 5.

### DETAILED DESCRIPTION

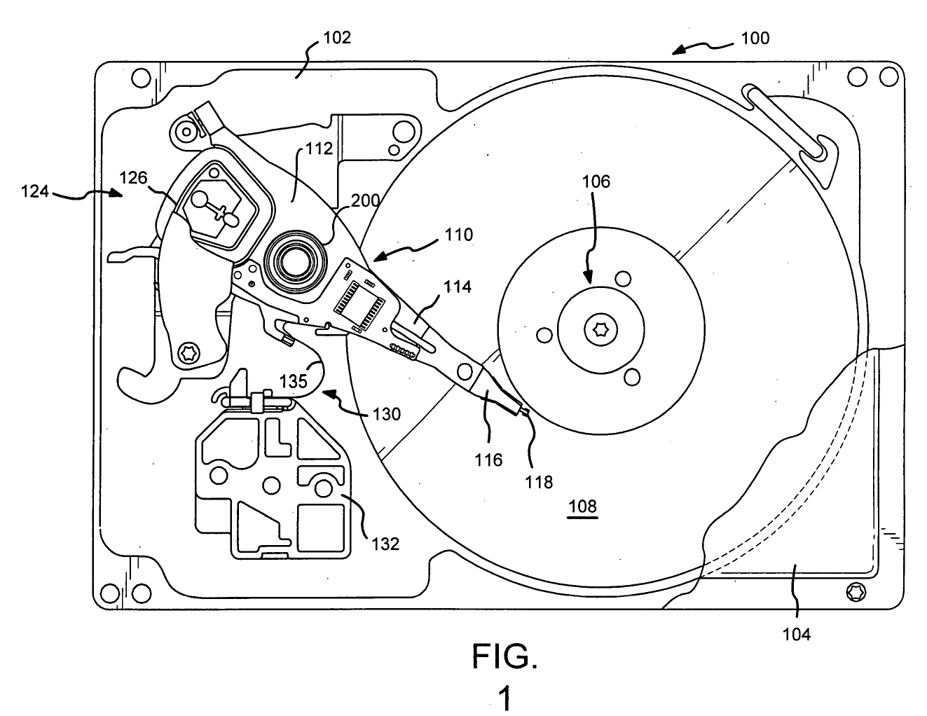

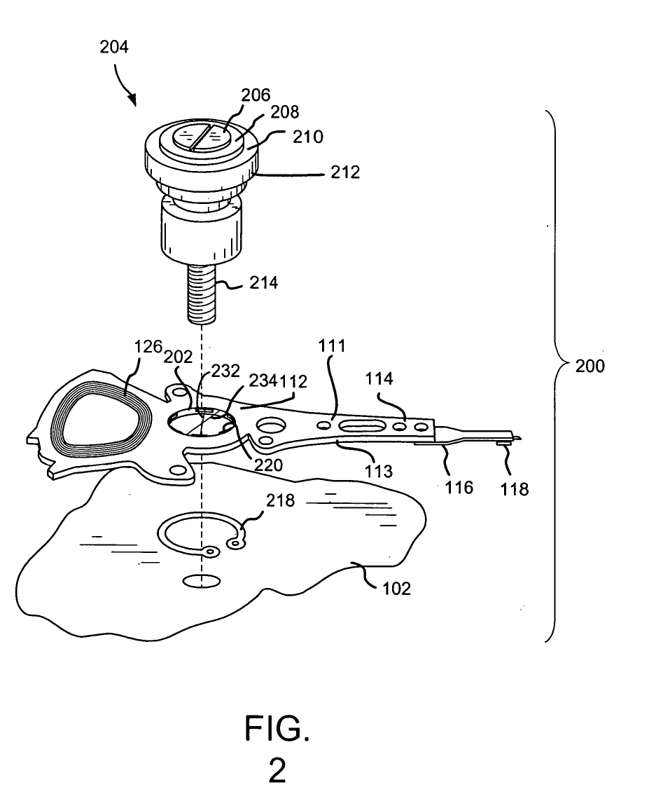

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 200 positioned adjacent the discs 108. The actuator assembly 110 includes a generally flat sheet metal actuator arm 114, with an integrated actuator body 112, which actuator arm 114 extends towards the discs 108, with one or more flexures 116 extending from the actuator arms 114. An actuator bore 202 is disposed in a medial portion of the actuator body 112 between an upper surface 111 and a lower surface 113 (FIG. 2) of the actuator body 112, which bore 202 pivots about the bearing shaft assembly 200. Mounted at the distal end of each of the flexures 116 is a head 118, which includes a fluid bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets (not shown) which establish a magnetic field in which the coil 126 is immersed. The controlled application of current to the coil 126 causes magnetic interaction between the permanent magnets and the coil 126 so that the coil 126 moves in accordance with the well-known Lorentz relationship. As the coil 126 moves, the actuator assembly 110 pivots about the bearing shaft assembly 200, and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a printed circuit board 132 connected to the actuator assembly 110 via a flex cable 135.

The actuator assembly 110 is shown in more detail in the exploded view of FIG. 2. The bearing shaft assembly 200 includes a bearing cartridge 204 having upper and lower bearings (not shown) with a stationary shaft 206 attached to an inner race 208 and a sleeve 212 attached to an outer race 210. The threaded bottom end 214 of the stationary shaft 206 is threaded into a hole (not shown) in the base plate 102. The sleeve 212 is press-fit and secured within the actuator bore 202 in the actuator body 112 by a plurality of tabs 220, so that the sleeve 212 and actuator body 112 are tightly joined to cause the actuator assembly 110 to pivot about the stationary shaft 206. The tabs 220 may be formed integrally with formation of the bore 202. A snap ring 218 fits around the sleeve 212 near the lower surface 113 of the actuator body 112 adjacent the base plate 102.

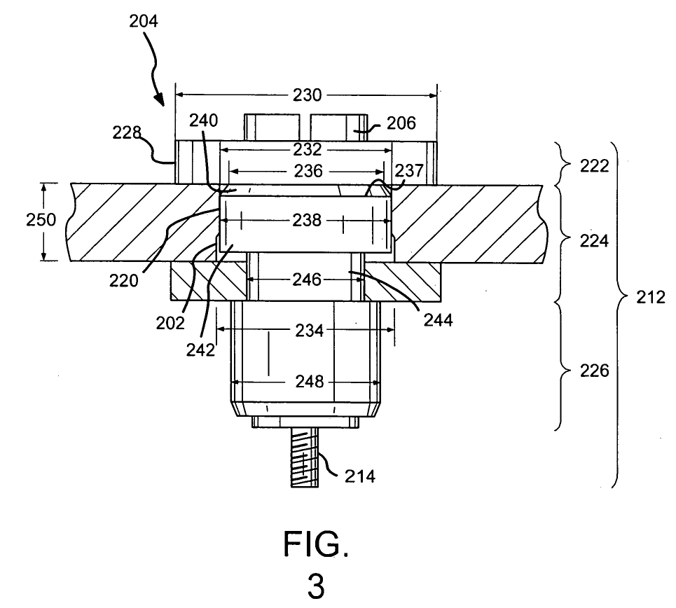

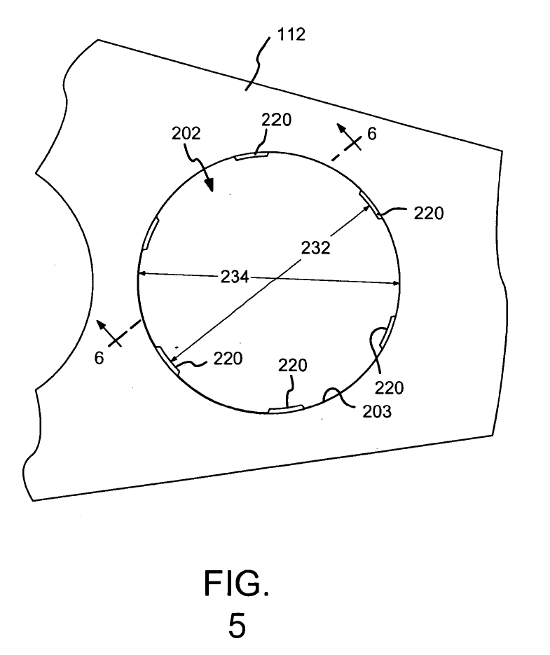

FIG. 3 shows the tight press-fit connection between the actuator body 112 and the sleeve 212 in more detail. The sleeve 212 has an upper region 222 located above the actuator body 112, a middle or contact region 224 located generally within the actuator bore 202, and a lower region 226 located below the actuator body 212. The tabs 220 in the actuator bore 202 do not extend through the entire thickness or depth 250 of the actuator body 112 for reasons that will be discussed later. The upper region 222 has a flange 228 with a diameter 230 that is larger than a diameter 232 of the actuator bore 202 between the tabs 220 (“tabs diameter 232”) and larger than a diameter 234 of the actuator bore 202 below and between the tabs 220 (“bore diameter 234”) (See FIG. 5). The contact region 224 begins directly below the flange 228 and has a tapered annular surface 240 having an upper diameter 236 that is less than the tabs diameter 232 and merges into a cylindrical contact surface 242 below the tapered surface 240. The contact surface diameter 238 is equal to or slightly larger than the tabs diameter 232 but less than the bore diameter 234. The bottom of the contact portion 224 comprises an annular groove or channel 244 that is located next to and below the contact surface 240. The channel 242 has a diameter 246 that is smaller than the contact surface diameter 238. The lower region 226 of the sleeve 212 begins adjacent to the channel 242 and has a diameter 248 that is larger than the channel diameter 246 but smaller than the tabs diameter 232.

In sum, the channel diameter 246 is less than the angled surface upper diameter 236 and lower diameter 248. The lower diameter 248 is less than the tab diameter 232. The tab diameter 232 is less than or equal to the contact surface diameter 238. The contact surface diameter 238 is less than the bore diameter 234. The bore diameter 234 is less than the flange diameter 230.

In this way, the bearing cartridge may be inserted through the actuator bore 202 as shown in FIG. 2. Specifically, because the lower region diameter 248 and the channel diameter 246 are smaller than the tabs diameter 232, the lower region 226 and the channel 244 slide right through the actuator bore 202. After the channel 244 has passed through the bore 202, the tabs 220 will make contact with the contact surface 242. Because the contact surface diameter 238 and the tabs diameter 232 are approximately the same size, the contact surface 242, and thus the bearing cartridge 204, will fit tightly between the circumferentially spaced tabs 220. Indeed, pressure may need to be applied to the upper region 222 of the sleeve 212 in order to push the sleeve 212 into the bore 202 until the flange 228 makes contact with the upper surface 111 of the actuator body 112. Because the flange diameter 230 is larger than the tabs diameter 232 and the bore diameter 234, the flange 228 acts as a stop to prevent the bearing cartridge 204 from sliding all the way through the actuator bore 202. However, it should be noted that the pressure fit between the tabs 220 and the contact surface 242 is likely enough to act as stop in and of itself.

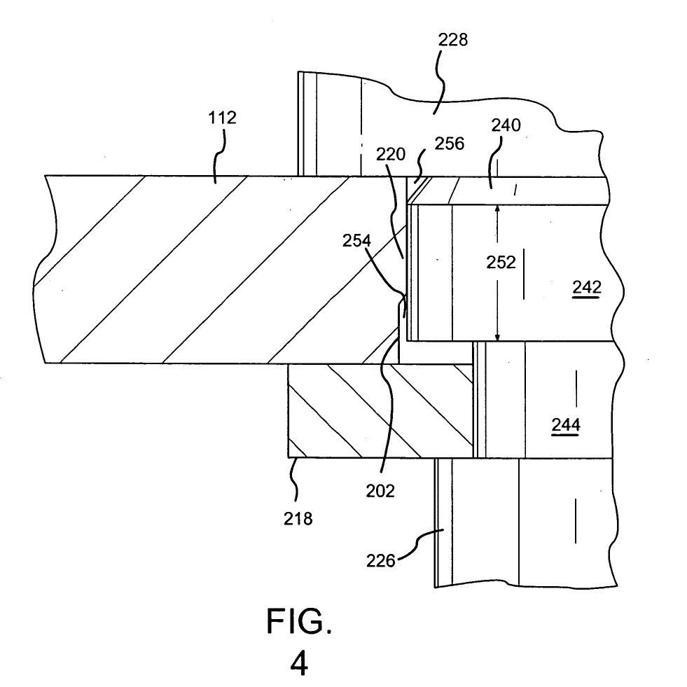

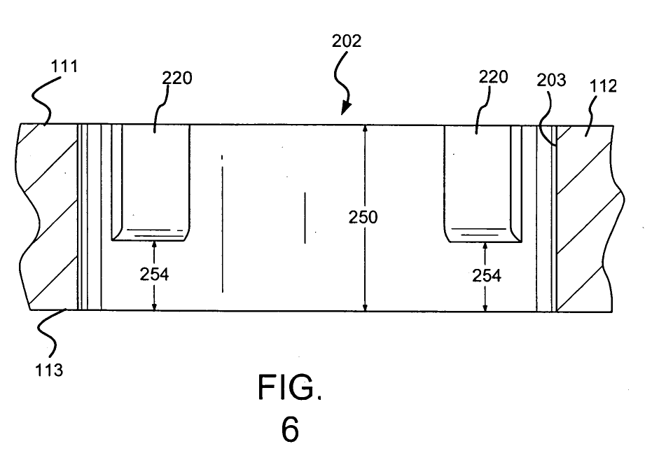

The size and position of the tabs 220 are important to form a secure and tight centered connection between the actuator body 112 and the bearing cartridge 200 that is not so tight that it will adversely affect the movement of the upper and lower bearings within the bearing cartridge 200. That is, if there is too much pressure between the tabs 220 and the contact surface 242, this pressure will be passed through the sleeve 212 onto the bearings and may create performance problems for the actuator assembly 110, such as undesirable noise, that in turn increases the overall noise of the disc drive 100. On other hand, if the connection between the tabs 220 and the contact surface 242 is not tight enough, the actuator arm 114 and the coil 126 will wobble and cause disc drive 100 performance problems. This connection is made tight enough, but not too tight, in at least two ways. First, as best shown in FIG. 6, an even number of tabs 220 project inward from and are spaced equally around an interior surface 203 of the actuator bore 202, thereby creating the smaller tabs diameter 232 and the larger bore diameter 234. In this way, only the tabs 220 contact the contact surface 242 of the sleeve 212. Second, as mentioned above and shown best in FIGS. 4 and 6, the tabs 220 do not extend through the entire depth 250 of the bore 202. Thus, the tabs 220 do not touch an entire depth 252 of the contact surface 242. The shorter length of the tabs 220 creates an open expansion space 254 (FIG. 4) below each tab 220. As the bearing cartridge 204 is pressed into the actuator bore 202, pressure is exerted onto the tabs 220 via the contact surface 242. This causes the tabs 220 to deform to conform to the contact surface shape 242. The expansion space 254 provides room to accommodate any displaced tab material, and thus limits the pressure, which relieves some pressure on the contact surface 242, and thus the bearings, while ensuring the tight connection between the tabs 220 and bearing cartridge 204. A second expansion space 256 is formed by angled surface 240 and the size difference between its upper diameter 236 and the lower diameter 237. The second expansion space 256 provides additional pressure relief for the tabs 220.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, although FIG. 5 and FIG. 6 show six tabs 220 evenly spaced apart, any number of tabs may be used so long as there is sufficient space between the tabs to exert the right amount of pressure on the contact surface 242. Although the tabs are shown with a generally square shape, they may be formed in any number of shapes. Moreover, while the tabs 220 are shown extending more than half of the depth 250 of the actuator bore 202; they may extend less than half of the depth 250. Numerous other changes may be made which will readily suggest themselves to those skilled in the art and which are encompassed in the spirit of the invention disclosed and as defined in the appended claims.

What is claimed is:

1. An actuator arm for use in a rotary actuator assembly having a bearing cartridge assembly with a stationary shaft adapted to be fastened to a disc drive base plate and an outer bearing sleeve rotatably connected to the stationary shaft, the actuator arm comprising:
a generally flat sheet metal body having upper and lower surfaces and an actuator bore passing therebetween, wherein the actuator bore is sized to receive the bearing cartridge assembly therethrough; and
a plurality of tabs projecting inward from an interior surface of the actuator bore, wherein the tabs extend only partially along a depth of the actuator bore between the upper and lower surfaces, wherein the tabs contact and secure the bearing cartridge assembly within the actuator bore.

2. The actuator arm of claim 1 wherein the plurality of tabs comprises six tabs.

3. The actuator arm of claim 1 wherein each of the tabs extends more than half way between the upper and lower surfaces in the bore of the depth of the actuator assembly.

4. The actuator arm of claim 1 wherein an expansion space is formed below each of the tabs between the interior surface of the actuator bore and the sleeve of the bearing cartridge assembly when the bearing cartridge assembly is inserted in the bore.

5. The actuator arm of claim 1, wherein the sleeve has a flange having an outer diameter greater than a diameter of the actuator bore.

6. An actuator assembly for use in a data storage device, that actuator assembly comprising:
a single actuator body having upper and lower surfaces and a circular bore therethrough, the circular bore having a bore diameter and a plurality of tabs projecting from an interior surface of the actuator body into the actuator bore, wherein the tabs extend only partially between the upper and lower surfaces of the actuator body; and
a bearing cartridge assembly having a stationary shaft connected to the disc drive housing and an outer sleeve rotatably connected to the stationary shaft, wherein the sleeve is press-fit into and secured within the actuator bore by the tabs.

7. The assembly of claim 6 wherein the plurality of tabs are equally spaced around the actuator bore.

8. The assembly of claim 7 comprising an even number of tabs.

9. The assembly of claim 7 comprising six tabs.

10. The apparatus of claim 7 wherein a diameter of the actuator bore between a pair of opposite tabs is equal to a diameter of the sleeve of the bearing cartridge.

11. The assembly of claim 7, wherein the sleeve comprises a flange located above the actuator body, a contact region located generally within the actuator bore, and a lower region located below the actuator body.

12. The assembly of claim 11 wherein each tab extends only partially along the actuator bore.

13. The assembly of claim 12 wherein the bearing sleeve, the tabs, and the actuator bore together define an expansion space below each of the tabs.

14. The assembly of claim 6 wherein the actuator assembly comprises only a single actuator body supported on the bearing cartridge assembly.

15. The assembly of claim 14 further comprising a snap ring fastened in an annular groove beneath the actuator body on the bearing sleeve to retain the actuator body on the sleeve.

16. A disc drive comprising:
an actuator assembly;
a bearing cartridge assembly having a stationary shaft connected to the disc drive housing and a sleeve pivotally connected to the stationary shaft; and
means for attaching the actuator assembly to the sleeve of the bearing cartridge assembly.

17. The disc drive of claim 16 wherein the actuator assembly has upper and lower surfaces and an actuator bore disposed therebetween and the means comprises a plurality of tabs connected to an interior surface of the actuator bore, wherein the tabs extend only partially between the upper and lower surfaces of the actuator assembly.
